(19) United States
(12) Patent Application Publication
(10) Pub. No.: US 2008/0005529 A1
(43) Pub. Date: Jan. 3, 2008

(54) Methods, Systems, and Computer Program Products for Providing Access to Addressable Entities Using a Non-Sequential Virtual Address Space

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/428,338

(22) Filed: Jun. 30, 2006

(51) Int. Cl. G06F 12/00

(52) U.S. Cl. 711/207

(57) ABSTRACT

Methods, systems, and computer program products for providing access to addressable entities using a non-sequential virtual address space are disclosed. An identifier from a non-sequential address space is assigned to an addressable entity. The identifier corresponding to the addressable entity is associated with a first memory location for storing the corresponding addressable entity. The identifier corresponding to the addressable entity is used in a first machine code instruction to access the addressable entity from the first memory location for processing the first machine code instruction by a processor.

### RELATED APPLICATIONS

This application is related to U.S. patent application Ser. No. ______, titled “Methods, Systems, and Computer Program Products for Generating and Using Object Modules,” (Attorney Docket No. I411), filed on even date herewith and assigned to the same assignee as this application, and U.S. patent application Ser. No. ______, titled “Methods, Systems, and Computer Program Products for Providing a Program Execution Environment,” (Attorney Docket No. I370), filed on even date herewith and assigned to the same assignee as this application, and U.S. patent application Ser. No. ______, titled “Methods, Systems, and Computer Program Products for Using a Structured Data Storage System to Provide Access to Addressable Entities in Virtual Address Space” (Attorney Docket No. I427), filed on even date herewith and assigned to the same assignee as this application, the disclosures of which are incorporated here by reference in their entirety.

### BACKGROUND

Computer systems utilize a technology known as virtual memory to provide a processor addressable memory space larger than the available processor physical memory accessible to the microprocessor instruction set. Virtual memory that is in use but not currently mapped to processor physical memory is stored in a swap space in persistent memory. The size of the swap space is limited, since most of persistent memory is reserved for use by the file system. This virtual address space is sequential in that it is a flat, linear, mathematically based address space. Because the address space is flat, linear, and mathematically based, hackers can easily manipulate code and data at locations within the virtual memory space and cause the microprocessor to jump to those locations, which can be easily determined by the hacker using simple address arithmetic to be valid addressable space. As well, conventional computer systems map executables into a virtual address space in a predictable manner using a documented format. An executable in virtual memory typically has one or more data segments for global and static variables, and constants, one or more code segments for instructions, one or more stacks to manage call invocation and instance data, and a heap region reserved for dynamically allocated program memory. This predictable structure combined with address arithmetic and a lack of runtime type and constraint checking enables hackers to write executables that may, for example, overwrite stack data, cause buffer overflow, and otherwise disrupt normal operation to gain unauthorized access to system resources.

In addition to security issues, the physical address spaces of persistent memory and processor memory are distinct. As a result, executables and data are stored in a format compatible with the use of persistent memory, and must be loaded and converted into a different format in processor memory to enable processing of the executables and data by the processor. Since virtual memory occupies both processor physical memory and a portion of persistent memory, executables and data may consume persistent memory in their persistent memory format and virtual memory either in processor physical memory or in persistent memory in swap space in a format compatible with processing. Further, executables and data may not remain in virtual memory indefinitely because of the limited size of processor physical memory and swap space available for virtual memory. More specifically, within the virtual memory space, a resource such as an application or a file may be stored in persistent memory and an instance of the resource may be loaded and linked into processor physical memory for processing by the processor when a resource instance is loaded into virtual and/or processor physical memory for processing. Changes made to the resource or by the resource to another loaded resource may be stored to persistent memory during processing of the resource instance or upon completion of the processing by a processor.

Upon termination of a resource instance or when processor physical memory limitations require, another resource instance may be loaded or swapped into processor physical memory and accessed by the processor from the location previously occupied by the initial resource instance. When the processor attempts to access the initial resource again, by processing a machine-code instruction including a virtual address associated with the resource, the initial resource is reloaded from swap space or reloaded and re-linked from persistent memory. The repeated accessing of persistent memory for resource linking and loading, coupled with duplicate use of available processor physical memory and persistent memory, causes performance degradation.

Accordingly, in light of these difficulties associated with conventional flat, linear, mathematically based virtual memory systems, there exists a need for improved methods, systems, and computer program products for providing virtual memory.

### SUMMARY

Methods, systems, and computer program products for providing access to addressable entities using a non-sequential virtual address space are disclosed. An identifier from a non-sequential address space is assigned to an addressable entity. The identifier corresponding to the addressable entity is associated with a first memory location for storing the corresponding addressable entity. The identifier corresponding to the addressable entity is used in a first machine code instruction to access the addressable entity from the first memory location for processing the first machine code instruction by a processor.

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport instructions for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a portable digital video disc (DVD), a wired network connection and associated transmission medium, such as an ETHERNET transmission system, and/or a wireless network connection and associated transmission medium, such as an IEEE 802.11(a), (b), or (g) or a BLUETOOTH transmission system, a wide-area network (WAN), a local-area network (LAN), the Internet, and/or an intranet.

Thus, the subject matter described herein can be embodied in many different forms, and all such forms are contemplated to be within the scope of what is claimed.

### BRIEF DESCRIPTION OF THE DRAWINGS

Preferred embodiments of the subject matter described herein will now be explained with reference to the accompanying drawings of which:

FIG. 1A is a block diagram of an exemplary computer system for providing access to addressable entities within a structured memory using identifiers from a non-sequential or sequential virtual address space supported by a memory management system (MMS).during processing of a machine-code instruction by a processor according to an embodiment of the subject matter described herein;

FIG. 1B is a block diagram of an exemplary computer system for providing access to addressable entities within both a structured and conventional memory using identifiers from both a sequential and non-sequential virtual address space supported by a memory management system using a structured data storage system (SDSS) during processing of a machine-code instruction according to an embodiment of the subject matter described herein;

FIG. 2 is an exemplary register structure to provide a logical organization for storing and operating upon IDs associated with addressable entities according to an embodiment of the subject matter described herein;

FIG. 3A is an exemplary page table entry compatible with a structured memory that may be indexed within a page table by use of an ID to map between sequential and non-sequential virtual addresses and processor physical memory (RAM) addresses according to an embodiment of the subject matter described herein;

FIG. 3B is an exemplary map table entry compatible with a structured virtual memory that may be indexed within a map table by use of an ID to map between non-sequential or sequential virtual addresses and persistent memory addresses according to an embodiment of the subject matter described herein;

FIG. 4 is an exemplary format for a virtual address format enabling a memory management system capable of supporting a non-sequential or sequential address space and structured memory depicting exemplary mappings to persistent memory and run-time, physical memory;

FIG. 5 is a flow chart illustrating a process for accessing an addressable entity assigned an identifier from a non-sequential address space associated with in a memory location according to an embodiment of the subject matter described herein;

FIG. 6 is a flow chart illustrating a process for providing access to addressable entities associated with identifiers from a virtual address space utilizing a structured data storage system according to an embodiment of the subject matter described herein;

FIG. 7 is a flow chart illustrating a process for assigning, associating, and accessing addressable entities in a structured memory using identifiers from either a non-sequential or a sequential virtual address space according to an embodiment of the subject matter described herein; and

FIG. 8 is a flow chart illustrating a process for accessing addressable entities in both conventional virtual memory and structured virtual memory supported by a structured data storage system according to an embodiment of the subject matter described herein.

### DETAILED DESCRIPTION

In view of the problems described above with respect to conventional virtual memory computer systems, the subject matter described herein provides for virtual memory using a memory management system (MMS) managing processor physical memory and persistent memory. Where previously a virtual address space was flat, linear, and mathematically based, the methods, systems, and computer program products described herein provide for providing access to a virtual address space using a structured data storage system (SDSS), and the virtual address space can be non-sequential. By adapting the processor and memory architecture to utilize a SDSS, such as a database management system, to manage items associated with identifiers from the virtual address space, mathematical calculations no longer provide a simple means by which hackers may execute malicious code. Load times for executable programs may also be improved as a result of the description herein because linking may be performed for a program executable one time and the linked references may be stored to the SDSS persistently. Subsequent changes to physical memory locations may be handled within the MMS without the need of a relinking operation. Accordingly, rather than performing a link operation at each execution of a program, an executable may be loaded with its associated addressable entities already linked within the SDSS. As a result, system performance may be improved. While this description addresses aspects related to a non-sequential virtual address space and use of a structured memory supported by an SDSS to facilitate operations using identifiers from the non-sequential virtual address space, the description herein is well suited for use with identifiers from sequential address spaces as well. Accordingly, use of an SDSS with both a non-sequential and a sequential virtual address space are within the scope of the subject matter described herein.

In addition, while an MMS having an SDSS is shown and described, it should be understood that according to an embodiment of the subject matter described, a more conventional MMS can be used with a non-sequential virtual address space to provide the advantages described above. That is, according to an embodiment, an MMS can be used for providing access to addressable entities using a non-sequential virtual address space without necessarily including some or all of the components and features of the SDSS described below.

As used herein, the term “program” or “executable” refer to any data representation that may be translated into a set of machine code instructions and associated program data. Thus, a program or executable may include an application, a shared or non-shared library, and a system command. Program representations other then machine code include object code, byte code, and source code.

Object code includes a set of instructions and/or data elements that are either prepared for linking prior to loading or are loaded into an execution environment. When in an execution environment, object code may be fully linked or may contain one or more unresolved references. The context in which this term is used will make clear that state of the object code when it is relevant. This definition can include machine code and virtual machine code, such as Java TM byte code.

As used herein, an addressable entity is any data that may be stored in a storage location and located/addressed using an identifier associated with the storage location. Addressable entities may be a part of a computer program or they may be data, which exists apart from a program executable such as a file or a portion of a file. A program addressable entity is a portion of a program specifiable in a source code language, which is addressable within a compatible execution environment. Examples of program addressable entities include variables including structures, constants including structured constants, functions, subroutines, methods, classes, anonymous scoped instruction sets, and individual instructions, which may be labeled. Strictly speaking, the addressable entity contains a value or an instruction, but it is not the value or the instruction. In some places, this document will use addressable entity in a manner that refers to the content or value of the entity. In these cases, the context will clearly indicate the intended meaning. Program addressable entities may have a number of corresponding formats. These formats include source code, object code, and any intermediate formats used by an interpreter, compiler, linker, loader, or equivalent tool. Thus, terms such as addressable source code entity may be used in cases where the format is relevant and may be unclear from the context.

The term “structured data storage system” (SDSS), as used herein, refers to a system for managing memory using distinct, structured memory areas identified using logical identifiers (IDs) and structured according to a data schema known to the SDSS. An SDSS typically uses many data schemas since it manages a variety of structured data. Accordingly, an entity stored in an SDSS is data stored in a storage location associated with an identifier for the location and the data stored in the location is associated with a schema known to the SDSS. The terms “structured memory,” “structured virtual memory,” “structured storage region,” and like terms are used interchangeably. For example, an SQL DBMS that supports structured tables with unique names and records with formats corresponding to their associated table's structure and identifiers qualifies as an SDSS for purposes of this description. Examples of other database management systems suitable for use with the subject matter described herein include relational database management systems, object oriented database management systems, and other DBMS-like systems. An SDSS does not require most of the features supported by current database management systems. Any memory storage system meeting the definition will suffice for the system and method described. An SDSS may include software that executes on a hardware platform, such as a general purpose computing platform, to implement a structured data store.

An SDSS is capable of supporting storage locations containing structured data where the structure is known to the SDSS and is capable of supporting a sequential identifier space or a non-sequential identifier space. The term “SDSS” when used as an adjective describing an entity represented by a noun indicates the entity may be compatible with a non-sequential address space, a sequential address space, a hybrid of the two, or both.

The term “persistent memory” or “persistent storage,” as used herein, may refer to any storage medium capable of storing resources in a manner that survives during periods with no power, such as reboots of a system. Examples of persistent memories suitable for use with embodiments of the subject matter described herein include hard-disk memory devices, removable persistent media, such as diskettes and other non-volatile storage devices.

“Processor physical memory” may refer to memories that are physically addressable by a processor via a processor register such as an instruction pointer (IP) register or addressable via a physical address by a processor during processing of a machine code instruction. Examples of physical memory include various types of random access memory (RAM), read only memory (ROM), and any memory within a processor's physical execution environment. Persistent memory media and processor memory media may generally be considered distinct. However, there are exceptions. For example, flash memory may be persistent and may be physically accessible to a processor during execution of a machine code instruction, which also qualifies it as processor memory. Memory as used herein includes processor physical memory and persistent physical memory. Virtual memory may be mapped to processor physical memory and to persistent physical memory. The mappings of virtual memory to processor physical memory and persistent physical memory may change over time. Accordingly, virtual memory and memory are not considered equivalent for purposes of this description. Identifier (ID) and virtual address are used interchangeably herein when referring to an address within a virtual address space, unless the context indicates a different meaning.

An MMS enabled to support a non-sequential address space may provide for management of distinct memory areas enabling each memory area to be addressed by ID/address from a non-sequential address space. A non-sequential address space may be implemented using a sequential address space in either a sparse and/or a random fashion, where address arithmetic is not supported in general. Within a sequential address space, there may be unused regions distributed in a random manner throughout the sequential address space. Accordingly, sequential address spaces may also provide a non-sequential environment. In an alternate embodiment of a sequential address space supporting a non-sequential address space, a processor may detect and prohibit address arithmetic in specified processing contexts.

Based upon the description herein, non-sequential memory address spaces may be identified and accessed using numeric and/or non-numeric addresses or IDs. Further, a mixture of data types may also be used as addresses or IDs. Memory management systems using an SDSS may be used to index memory IDs and may be considered to meet threshold functional operability for use in a memory management system (MMS) capable of supporting a non-sequential address space. Memory management systems including an SDSS can support many additional features, which add additional performance, data integrity, and/or security features to a memory management system over the base system. These additional features are not required to support either the non-sequential or structured aspects of the memory management system described herein. It should be noted that a memory management system may support both a sequential and a non-sequential address space for purposes of the description herein while also providing an enhanced runtime environment through the use of additional features. Accordingly, use of an SDSS may provide advantages over traditional virtual memory systems in addition to or rather than providing a non-sequential virtual address space for purposes of this description.

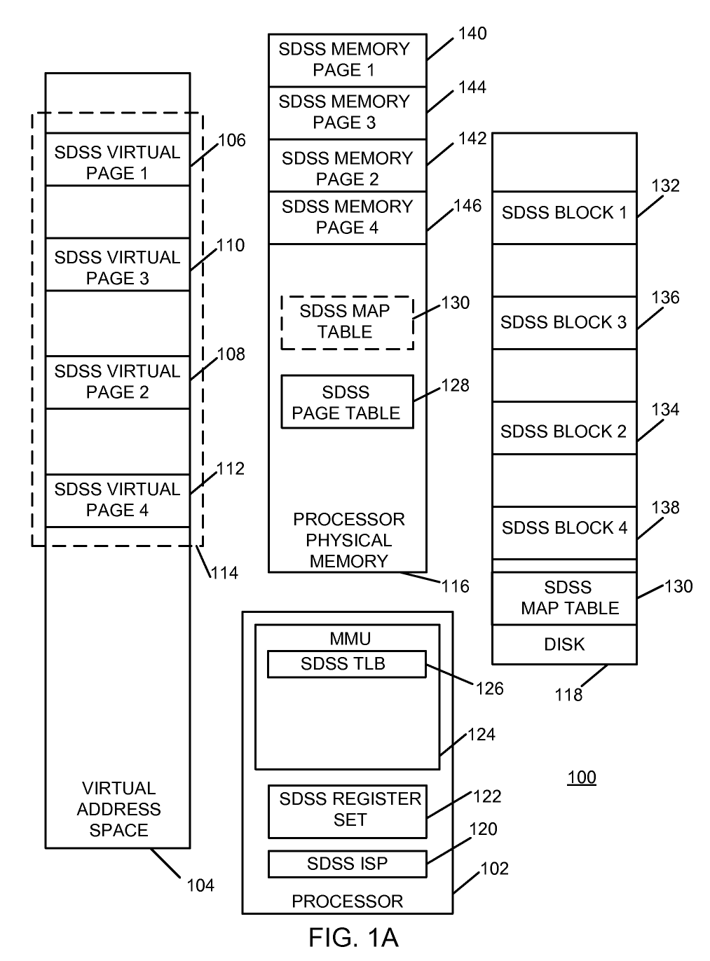

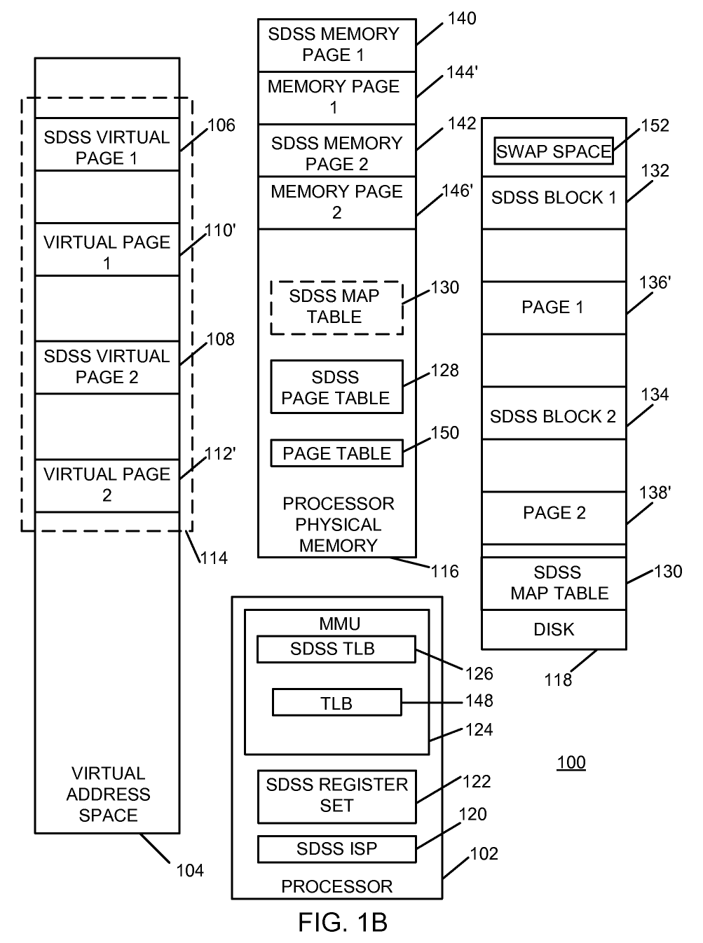

FIG. 1 A illustrates an exemplary computer system 100 for providing access to addressable entities in a structured memory using a non-sequential or a sequential virtual address space during processing of a machine-code instruction including a virtual address. The address space is supported by a memory management system including an SDSS capable of associating physical memory addresses with virtual addresses, as described above. By associating an identifier from the SDSS virtual address space 104 with each of the addressable entities and by associating each of the identifiers of the addressable entities in an SDSS virtual memory with the addresses of the physical location where the addressable entities exist; security, integrity, and performance may be improved over conventional virtual memory computer systems. Support for a structured memory and a non-sequential address space are independent. Embodiments of computer system 100 may support one or both. The description of the preferred embodiment describes both, and thus enables embodiments supporting a non-sequential address space without structured memory and embodiments supporting structured memory and a sequential address space.

Computer system 100 provides for locating addressable entities (e.g., executable program functions, program objects having an executable component, virtual registers, executable program methods, executable program subroutines, scoped code blocks, labeled instructions, parameters, tables, arrays, program data variables, and data constants, etc.) using identifiers (IDs) from the SDSS virtual address space for the addressable entities, whether the addressable entities are stored in a processor physical memory (e.g., RAM) or stored in persistent memory medium (e.g., a disk). Because both processor physical memory and persistent memory may be used to underlie the SDSS virtual address space 104, both may be considered a part of the execution environment, since the processor is enabled to detect SDSS identifiers as addresses as described later.

Within computer system 100, addressable entities may be loaded into the SDSS virtual address memory of the execution environment. An ID from the SDSS virtual address space may be assigned to each addressable entity, and the assignment may remain persistent for the addressable entities and may survive termination of their associated executable instance(s) and reboots of the system. When an addressable entity is moved from either persistent memory to processor physical memory or is otherwise moved to a new physical location, the ID may be mapped to the physical address of the new location without requiring a separate link phase the next time the addressable entity is accessed by the processor. In addition, since the virtual address space spans both processor physical memory and persistent memory, the addressable entity does not need to be unloaded from the virtual memory upon termination of its associated executable instance. Accordingly, the associated executable instance and/or associated static entities may remain in SDSS virtual memory between reboots of the system. For example, a C programming language routine may be assigned an ID. This ID may be in the form of a universal identifier (UUID) or other valid identifier of an SDSS virtual storage area. If labels are present within the routine or scoped code blocks that may be referenced by the routine, each may be assigned a UUID as well. Alternatively, labels within a routine or scoped code block may be treated as being contained within the routine and may be assigned sub-IDs, such as integer index numbers that are unique within the domain of the UUID assigned to the routine. In the latter case, a location within a routine may be referenced using an identifier of the form UUID [index]. Alternately, the area within an SDSS virtual memory location identified by an ID may be treated as a flat address space allowing addresses of the form ID[offset] or UUID[offset]. The ID[index] form may be more secure since the arrangement of the sub-entities may be randomized in an underlying physical address space.

Because a file system may be implemented using an SDSS for storage of file data, a file system may use the same SDSS supporting the memory management system described herein. Accordingly, a file system may be included in the virtual memory and accessed using identifiers from the virtual address space 104 provided by the SDSS and distinct persistent storage address spaces and storage formats are not needed. As a result, system resources may be managed within a single virtual memory using a single virtual address space 104.

The virtual address space 104 may be created, for example, by using domains and sub-domains, similar to those used within lightweight directory access protocol (LDAP) directories and uniform resource locators/uniform resource identifiers (URLs/URIs). In this way, the address space 104 may be non-sequential and logically correlated to the virtual memory of system 100 by use of an SDSS, as will be described in more detail below. Alternately the IDs may be assigned in a random fashion or may be assigned randomly within a domain or region in the address space.

As another example, objects within an object-oriented programming environment may be instantiated multiple times to create multiple instances of the associated objects. The data portion of each object instance may be assigned an ID, and each addressable data entity associated with each object data instance may also be assigned an ID within computer system 100. Each object instance may share the same executable portion also assigned an ID, which requires loading and linking into the SDSS virtual memory only once. Accordingly, any identifier scheme that provides for an ID for each addressable entity within computer system 100 may be suitable for use therein. For example, the ID may be an SDSS record ID where the SDSS embodiment uses a relational database to manage storage across both processor physical memory and persistent storage. The record ID may be used to access an addressable entity by reference to the SDSS record ID for resolving the physical address of the addressable entity. In this way, an SDSS may be used to provide address resolution during run time and physical address references may be modified over time without a need to re-link associations between addressable entities in the SDSS virtual memory.

The identifier may be mapped to a physical address in processor physical memory when the associated addressable entity is needed for processing and may be mapped to a physical persistent memory address when the associated addressable entity is not needed for processing. Once identifiers are assigned to addressable entities and associated with a physical address for the addressable entity, computer system 100 may act upon the addressable entities at a machine code level by using the identifier as a machine code operand or in a processor register operation. For example, an access to an addressable entity may be implemented with a memory management system and the ID may be used as a virtual memory location identifier, which the memory management system resolves to a physical address. Accordingly, addressable entities may be loaded very quickly when the identifier has been assigned. As well, when the ID is assigned and associated with the addressable entity, the association may be preserved and persisted across multiple terminations of an associated executable and reboots of the system since the SDSS virtual memory and virtual address space span both processor physical memory and persistent memory allowing the entire virtual memory to be stored in persistent memory and indefinitely supported by the memory management system. Thereby, subsequent link phases may be unnecessary. Using an identifier for each addressable entity and allowing the associated physical memory address to change depending on where the addressable entity is physically located, each addressable entity may be uniquely identified within computer system 100. By further maintaining the association between addressable entities and virtual memory locations and associated identifiers within a memory management system, the associations may be archived to persistent memory and retrieved during subsequent processing of an addressable entity without a need to re-link symbolic references. Thereby, performance improvements may be realized and load and link times may be reduced.

Some references to addressable entities within executables may be re-linked at run-time. An SDSS runtime linker may perform this function. SDSS runtime linking may be accomplished by maintaining a symbol table within the structured data storage system and performing dynamic symbol lookup and subsequent resolution of the SDSS virtual identifier of the referenced symbol to a physical address.

In FIG. 1A, computer system 100 includes a processor 102. Processor 102 may operate upon identifiers (e.g., database identifiers) from the virtual address space 104 at a machine code level, as will be described in more detail below.

The virtual address space 104 represents a view of addressable space and the associated virtual memory from the perspective of processor 102. The address space 104 may be non-sequential and may be associated with structured memory, although for ease of illustration the address space 104 is given a continuous and sequential appearance in the figure. An SDSS virtual page 1 106, an SDSS virtual page 2 108, an SDSS virtual page 3 110, and an SDSS virtual page 4 112 represent a mapping of an executable 114 within virtual address space 104. Executable 114 is mapped to virtual address space 104 and may be mapped to processor physical memory with a sequential physical address space from the perspective of processor 102. Addressable entities may be stored randomly across the physical address spaces available, but for performance reasons they may be grouped physically and/or virtually into blocks or pages in physical storage by an SDSS for more efficient swapping and locating. The addressable entities within a page or block may have addresses that are non-sequential within the SDSS virtual memory and/or may referenced structure memory locations. FIG. 1A depicts addressable entities grouped into blocks called pages for purposes of loading addressable entities in the SDSS virtual memory to and from processor physical memory and persistent physical memory.

Computer system 100 further includes a processor physical memory 116 and a persistent physical memory embodied as disk 118. Processor physical memory 116 may be any of various memory technologies compatible with the processor, such as random access memory (RAM) or read-only memory (ROM). Disk 118 may be any persistent memory device capable of storing and retrieving data including executable code, such as a hard disk.

Processor 102 includes an instruction set processor (SDSS ISP) 120 capable of processing machine instructions with virtual addresses and references as instruction operands where the operands have a format compatible with an SDSS virtual memory identifier. Processor 102 may query an SDSS table within SDSS virtual memory using an SDSS ID from either a sequential or non-sequential address space to locate addressable entities in physical storage. Accordingly, SDSS ISP 120 may operate upon machine-level computer instructions that include SDSS identifiers as operands, including the exemplary identifiers described above. An SDSS register set 122 may include registers capable of storing or referencing SDSS virtual addresses which can be resolved by the memory management system. At least a portion of the register set within SDSS register set 122 may be adapted to store virtual addresses and references to virtual addresses which include portions of identifiers which the memory management system may resolve to physically addressable entities, as will be described in more detail below.

The memory management system of system 100 includes a memory management unit (MMU) 124 with an SDSS translation lookaside buffer (TLB) 126, an SDSS page table 128, an SDSS map table 130, the SDSS register set 122 described above and configured to contain and/or reference SDSS virtual memory addresses, and microcode (not shown) for operation of the processor and machine-code (not shown) providing the processor instruction set programming, including programming for the operation of portions of the memory management system. Each component and its role will be described below.

Within processor 102, the memory management unit (MMU) 124 including the SDSS TLB 126 may perform address resolution operations using SDSS identifiers in the form of SDSS virtual addresses or SDSS virtual page numbers recently accessed by the processor 102. SDSS page table 128 may be located at least partially in processor physical memory 106 and may map SDSS virtual page numbers or SDSS virtual addresses from the SDSS virtual address space to processor physical page numbers or processor physical memory addresses, respectively. SDSS TLB 126 and SDSS page table 128 may perform memory translation operations similar to a conventional TLB and page table. However, instead of mapping conventional virtual page numbers from a conventional virtual address space to processor physical page numbers, SDSS page table 128 may map SDSS virtual page numbers or SDSS virtual addresses from SDSS virtual address space 104 to processor physical page numbers or processor physical memory addresses, respectively.

If an SDSS virtual page number or SDSS virtual address is not found in SDSS page table 128, SDSS map table 130 may be used to map the SDSS virtual page number or SDSS virtual address within SDSS virtual address space 104 to a physical address in disk 108. Accordingly, an SDSS block 1 132, an SDSS block 2 134, an SDSS block 3 136, and an SDSS block 4 138 may be used to map the SDSS virtual page number or SDSS virtual address within SDSS virtual address space 104 to a physical address in disk 108 for persistent storage. The memory management system may load and map an SDSS virtual page or SDSS virtual address into processor physical memory 106 by copying the associated SDSS block to enable processing of the contents. Accordingly, an SDSS page 1 140, an SDSS page 2 142, an SDSS page 3 144, and an SDSS page 4 146 may be used to map an SDSS virtual page or SDSS virtual address into processor physical memory 106. SDSS map table 130 may be stored in disk 108 and may have portions mapped to processor physical memory 106 for faster access of recently used addresses. Accordingly, SDSS map table 130 is represented within disk 108 with a solid-line representation and within processor physical memory 106 with a dashed-line representation.

FIG. 1B depicts an alternate embodiment in which both a conventional virtual address space and an SDSS virtual address space are supported. In addition to the components depicted in FIG. 1A, FIG. 1B depicts a conventional TLB 148, a conventional page table 150, a swap space 152, a conventional virtual memory page ‘110′ and a conventional virtual memory page 2 112′ mapped to both processor physical memory 116 and disk 118 as a memory page 1 144′, a memory page 2 146′, a page 1 136′, and a page 2 138′. All conventional components are supported by registers, processor microcode, and by software enabled for processing the conventional virtual address space. The memory management system components and the conventional memory management system components are illustrated as separate entities for ease of description. They may be implemented separately or combined. The conventional virtual memory and SDSS virtual memory and their associated address spaces are depicted as a single entity 104 for each of illustration, but are logically separate.

By providing support for both conventional virtual memory and SDSS virtual memory, computer system 100 may operate on both a conventional virtual memory organization and an SDSS structured virtual memory organization using either a non-sequential or a sequential virtual address space to allow a migration path for older executable system resources. However, computer system 100 may also operate without use of conventional virtual memory accesses without departure from the scope of the subject matter described herein.

It should be noted that the memory management system is capable of storing a context for the SDSS register set 122 and optionally for SDSS page table 128, SDSS TLB 148, and SDSS map table 130 into the SDSS virtual memory space. For example, a context for SDSS register set 122 may be mapped to SDSS virtual page 1 106 and stored within SDSS memory page 1 140 in processor physical memory 116. Accordingly, these components may be migrated to persistent physical memory, such as disk 118, as table sizes increase by moving older entries to disk 118 allowing machine and executable state information to be preserved between uses and even reboots of the system. In addition, addressable entities may simultaneously exist within processor physical memory 116 and disk 118 and, accordingly, the identifier associated with the addressable entity may be indexed within SDSS map table 130, SDSS page table 128, and SDSS TLB 126 simultaneously.

Portions of executable 114 may be loaded into conventional virtual memory while other portions may be loaded into SDSS virtual memory. This may be done under the direction of the program developer for any number of reasons. SDSS virtual page 1 106 and SDSS virtual page 2 108 include structured virtual memory regions that may be accessed by processor 102 using identifiers operating as SDSS identifiers to perform address resolution for addressable entities within computer system 100. Virtual page 1 110′ and virtual page 2 112′ may be viewed as conventional virtual pages containing portions of executable 114.

Portions of SDSS virtual memory associated with executable 114 may map onto both processor physical memory 116 and disk 118 for its persistent physical memory location. Processor physical memory 116 may also be partitioned into both SDSS regions and conventional sequentially addressable, unstructured memory regions. SDSS memory page 1 140 and SDSS memory page 2 142 may include SDSS entities referenced by identifiers operating as SDSS identifiers to provide address resolution for the addressable entities. Memory page 1 144′ and memory page 2 146′ may provide conventional sequentially addressable, unstructured memory regions within processor physical memory 116.

As with processor physical memory 116, disk 118 may also be partitioned into SDSS addressable regions and conventional sequentially addressable, unstructured regions. SDSS block 1 132 and SDSS block 2 134 may include addressable entities accessed by identifiers operating as SDSS identifiers to provide address resolution for the addressable entities. Page 1 136′ and page 2 138′ may provide sequentially addressable, unstructured regions within disk 118.

As can be seen from FIGS. 1A and 1B, processor 102 may support an SDSS virtual memory 104 that may be mapped onto processor physical memory 116 and disk 118. As described above, computer system 100 may operate entirely in an SDSS fashion as depicted in FIG. 1A or operate using both SDSS virtual memory and conventional virtual memory as depicted in FIG. 1B.

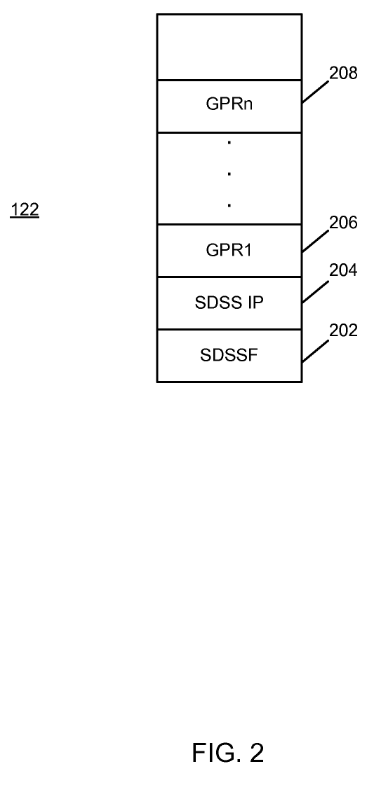

FIG. 2 illustrates an exemplary SDSS register set 122 in more detail. SDSS register set 122 may provide a logical organization for storing and operating upon identifiers associated with addressable entities, as well as values retrieved from virtual memory locations or produced by processor 102. One or more SDSS segment frame (SDSSF) registers 202 may be provided for holding and referencing SDSS memory addresses. Other registers may be provided for other purposes such as holding data values such as values calculated by the processor, values retrieved from SDSS virtual memory which may be used as address offsets. Exemplary registers include an SDSS instruction pointer register SDSS IP 204, a set of general purpose registers GPR1 206, up to a GPRn 208. Other registers compatible with address formats of a non-sequential and/or sequential virtual address spaces may also be provided.

As with conventional processors supporting multi-processing and threading, SDSS register set 122 may be saved to SDSS virtual memory and thus physical memory as a result of a context switch and restored to hardware-based registers when the associated process or thread is made active. The techniques for supporting this are similar to those associated with conventional virtual memory based systems. Further, SDSS register set 122 may be mapped to multiple physical hardware-based register sets that may likewise be context switched when the associated process or thread is made active.

While the embodiment described may use hardware-based SDSS register set 122, MMU 124 including SDSS TLB 148, and other processor 102 hardware components, the system may also, or alternatively, be virtualized and run within a virtual machine (VM) just as other processors and memory management systems are currently supported by VMs. Accordingly, some or all of the hardware components of system 100 may exist in memory in virtualized environments.

As described above, SDSS register set 122 may be abstracted onto SDSS virtual memory 104. However, there is no requirement that SDSS register set 122 be located in a sequential region of memory. As with any addressable entity within computer system 100, each field of SDSS register set 122 may be referenced by its own identifier, thereby allowing different portions of SDSS register set 122 to be placed in different regions of SDSS virtual memory 104.

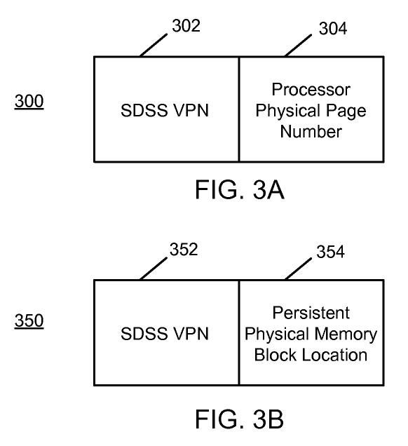

FIG. 3A illustrates an exemplary SDSS TLB entry 300 that may be indexed within SDSS TLB 126 by use of an SDSS virtual page number or SDSS virtual address to map between SDSS virtual memory, as illustrated in executable 104, and processor physical memory 116. As described above, SDSS TLB entries may be indexed with SDSS virtual page numbers (VPNs) or SDSS addresses. When an SDSS VPN references an SDSS TLB entry, such as SDSS TLB entry 300, an association between an SDSS virtual page number 302 and a processor physical page number 304 may be identified. SDSS virtual page number 302 is an SDSS virtual page number, such as a page number for SDSS virtual page 1 106. Accordingly, SDSS virtual page number 302 references a grouping of one or more addressable entities each with SDSS virtual addresses from within the SDSS virtual address space. Processor physical memory page number 304 references a fixed region of processor physical memory (RAM) 116. Accordingly, SDSS virtual memory address 302 may reference a physical address region 304 in processor physical memory 116. In this way, SDSS VPN 302 may be utilized by MMU 124 to access SDSS TLB 126 to resolve accesses to an addressable entity that is logically located within SDSS virtual memory associated with executable 114 and physically located within processor physical memory 116. SDSS page table 128 works in a manner similar to SDSS TLB 126.

FIG. 3B illustrates an exemplary SDSS map table entry 350 that may be indexed within SDSS map table 130 using an SDSS virtual page number or SDSS virtual address to map between SDSS virtual memory associated with executable 114 and disk 118. An SDSS virtual page number 352 is an SDSS virtual page number, such as SDSS virtual page 2 108. A persistent physical memory location 354 may store a physical address of persistent memory, such as an identification of a block, sector, and offset of SDSS block 2 134, within disk 118. Accordingly, a memory management system may use SDSS VPNs or SDSS virtual addresses to access SDSS map table entries, such as SDSS map table entry 350, within SDSS map table 130 to resolve accesses to addressable entities that are located within SDSS virtual memory associated with executable 114 and that are physically located on disk 118.

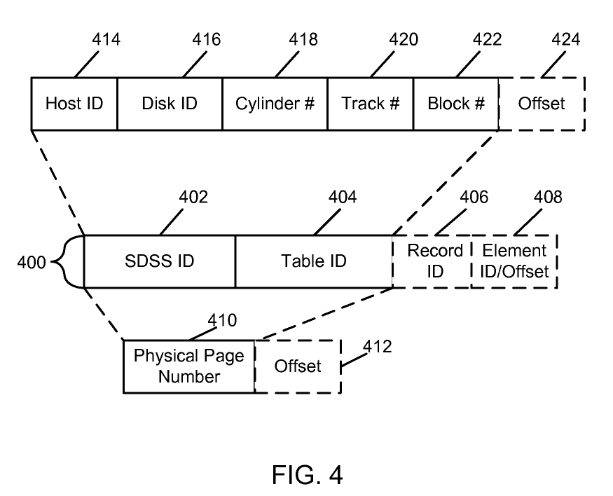

FIG. 4 illustrates an exemplary SDSS virtual address structure 400 for mapping an SDSS virtual address to a processor physical memory address format and that may be maintained within SDSS page table 128 and SDSS TLB 126. SDSS virtual address 400 includes an SDSS virtual page number having an SDSS identifier 402 which may identify a specific SDSS in an MMS and a Table ID 404 which may identify a specific table in the specific structured data storage system. The exemplary SDSS virtual address structure 400 format assumes an SDSS that maintains a table structure where tables have defined columns and records as in most SQL DBMSes. To identify a specific addressable entity a record ID 406 and an element ID or offset 408 may be included.

SDSS virtual address 400 may be mapped to a processor physical memory format by associating the VPN portion of the SDSS virtual page number with a processor physical page number (PPN) 410 in processor physical memory, such as processor physical memory 116. The sizes of the pages associated with the VPN and the PPN may match in size and may be determined based on system characteristics and requirements. An offset 412 may be included to identify a processor physical memory location of an addressable entity located at an offset in the PPN. The offset may be calculated by the memory management system from information about the table stored in the table's metadata and/or looked up in a lookup table for this purpose. Accordingly, given SDSS metadata and a record ID and optional element ID or offset, a corresponding offset in the associated PPN may be calculated.

SDSS virtual address 400 may also be mapped to a physical address format for a persistent memory location, such as a location on disk 118. SDSS virtual address 400 may be mapped to a persistent physical memory format by associating the VPN portion of the SDSS virtual address with a physical block location in persistent memory. For purposes of illustration, the persistent memory is disk 118. Accordingly, the particular block location includes an optional host ID 414 if the disk is managed by a remote host, an optional disk ID 416 if the device has more than one disk, a cylinder number 418, a track number 420, and a block number 422. The exact location of the addressable entity may include an offset 424 into the block, which may be kept in a lookup table in persistent memory or calculated using the record ID 406 and element ID or offset 408 within SDSS metadata stored in persistent memory. The sizes of the VPN and the persistent physical memory area PPN may match and may be determined based on system characteristics and requirements.

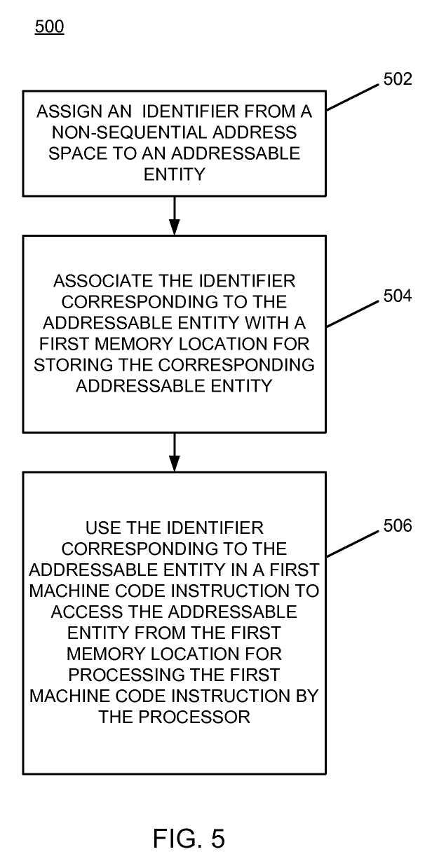

FIG. 5 illustrates an exemplary process 500 for accessing an addressable entity in a memory location with an identifier from a non-sequential address space associated with either a structured or unstructured memory. As described above, an identifier may be assigned to an addressable entity. At block 502, process 500 assigns an identifier to an addressable entity. For example, an identifier may be assigned to a static data variable during loading of a loadable object file into virtual memory by a loader (not shown) which may take the form of a script processor in a DBMS embodiment of an SSID. In a structured memory, an identifier may be assigned by the DBMS prior to populating a new row in a table associated with the type of the static variable.

At block 504, process 500 associates the identifier corresponding to the addressable entity to a first memory location for storing the corresponding addressable entity. For example, continuing with the example, the DBMS allocates physical storage for the new row in the table in either processor physical memory or persistent storage, then stores the assigned identifier as the primary key for the row, thus associating the identifier with the memory locations corresponding to the data variable. Depending on whether the physical memory is processor memory or persistent storage the SDSS page table 128 and/or the SDSS map table 130 are updated to associate the identifier with storage location's physical address. If the virtual memory location or its content is accessed by the process an SDSS TLB entry, such as SDSS TLB entry 300, may be created within SDSS TLB 126 as a result of the access by the processor and indexed using a portion of the identifier to associate the physical memory address of an addressable entity, such as a data variable, in response to the data variable being stored or designated for storage within processor physical memory 116. SDSS TLB entry 300 may then be used in block 504 to embodiment an additional association between the identifier used in the processing of the machine code instruction with a processor physical memory location.

At block 506, process 500 uses the identifier from a non-sequential address space corresponding to the addressable entity in a first machine code instruction to access the addressable entity from the first memory location in a structured virtual memory for processing the first machine code instruction by a processor. For example, during processing of a machine-code instruction where the identifier is a reference operand, SDSS ISP 120 may use the identifier corresponding to the addressable entity to access the addressable entity using SDSS TLB 126 during processing of the instruction if the identifier is in a TLB entry, such as SDSS TLB entry 300.

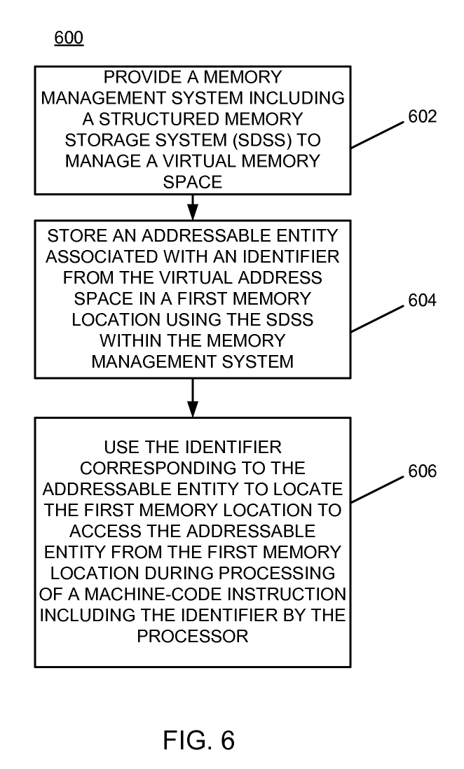

FIG. 6 illustrates an exemplary process 600 for providing access to addressable entities in structured memory utilizing an SDSS. At block 602, process 600 provides a memory management system including an SDSS to manage a virtual memory. At block 604, process 600 stores an addressable entity associated with an identifier in a first memory location using the SDSS within the memory management system. For example, an addressable entity may be stored in persistent physical memory. An identifier associated with the addressable entity may be stored in an SDSS map table entry 350 along with a portion of the persistent physical address of the physical storage location of the addressable entity.

At block 606, process 600 uses the identifier corresponding to the addressable entity to locate the first memory location to access the addressable entity from the first memory location within the virtual address space during processing of a first machine code instruction including the identifier by a processor. For example, the identifier may be used as a reference operand in a machine code instruction processed by SDSS ISP 120 to cause the memory management system to access an SDSS map table entry, such as SDSS map table entry 350 as indexed within SDSS map table 130 by a portion of the identifier. Once the persistent physical address of the addressable entity is located, the memory management system may map the SDSS virtual page in the SDSS physical block containing the addressable entity to a physical page in physical memory and update the SDSS page table 128 associating the VPN of the SDSS virtual page and the PPN of the processor physical memory page as depicted in SDSS page table entry 300. The addressable entity may be made accessible to the processor for processing the instruction through its location in processor physical memory. The address space may be sequential or non-sequential.

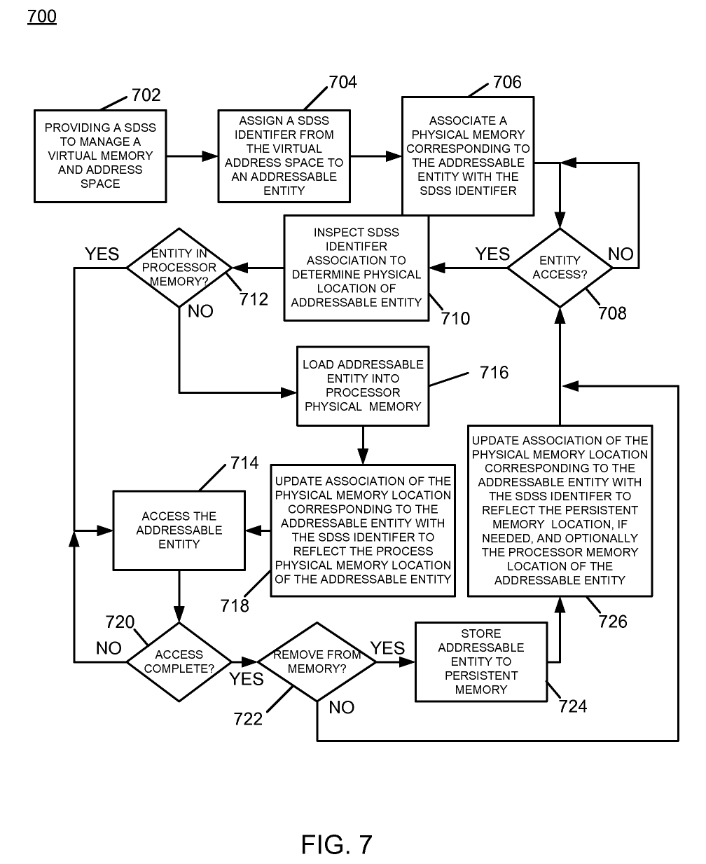

FIG. 7 illustrates an exemplary process 700 for assigning, associating, and accessing addressable entities within a virtual memory using a memory management system including a structured data storage system. At block 702, process 700 may provide an SDSS as part of a memory management system to manage a virtual memory and associated virtual address space. At block 704, an SDSS identifier from the virtual address space may be assigned to an addressable entity. At block 706, a physical memory location corresponding to the addressable entity may be associated with the SDSS identifier. At decision point 708, process 700 may wait for instruction requiring an addressable entity access.

When an addressable entity access has been requested, as determined at decision point 708, process 700 may inspect the SDSS identifier association to determine the physical location of the addressable entity at block 710. At decision point 712, process 700 may determine whether the addressable entity is in processor physical memory. When the addressable entity is in processor memory, the addressable entity may be accessed at block 714. When the addressable entity is not in processor memory, the addressable entity may be loaded into processor memory at block 716 from its associated persistent memory location. At block 718, the association of the processor memory location corresponding to the addressable entity with an SDSS identifier may be updated to reflect the processor memory location of the addressable entity in processor memory. As was the case, where the entity already existed in processor memory, as determined at decision point 712, when the association has been updated at block 718, the addressable entity may be accessed at block 714.

At decision point 720, process 700 may determine whether the access of the addressable entity is complete. When the access of the addressable entity is not complete, process 700 may iterate between accessing the addressable entity at block 714 and determining whether the access is complete at decision point 720. When the access of the addressable entity is complete, a determination may be made at decision point 722 as to whether the addressable entity should be removed from processor physical memory. If the addressable entity's value has not changed, its memory has not been modified, and the memory management system supports paging, then the processor physical memory may be reused without copying the addressable entity to persistent physical memory. If the addressable entity has been modified, or its memory page has been modified, it may be copied to persistent physical memory. When a determination has been made at decision point 722 to move or update the addressable entity to persistent physical memory, the addressable entity may be stored to persistent physical memory at block 724. At block 726, the association of the physical memory location corresponding to the addressable entity with the SDSS identifier may be updated, if needed, to reflect the persistent physical memory location of the addressable entity. When the addressable entry is removed from processor memory, its association with the processor physical memory may be updated to reflect its removal. When the association has been updated or when a determination has been made at decision point 722 not to move the addressable entity to persistent physical memory, process 700 may return to decision point 708 to await an instruction for an entity access. The address space may be sequential or non-sequential.

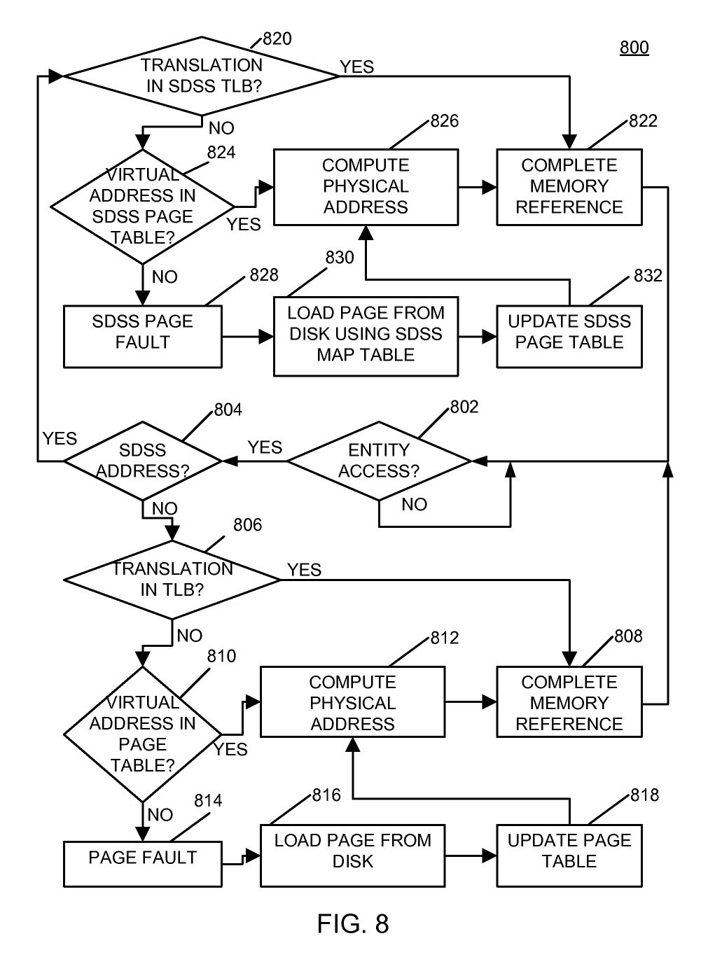

FIG. 8 illustrates an exemplary MMS process 800 for accessing addressable entities in both conventional virtual memory and SDSS virtual memory, which may be associated with a non-sequential or sequential address space. At decision point 802, process 800 may await an instruction including an addressable entity access or process instructions until an entity access occurs. When an access has been requested, a determination may be made at decision point 804 as to whether the address associated with the addressable entity is an SDSS virtual address. When the address is not an SDSS virtual address, a check is made for a translation in a conventional TLB at decision point 806. When a translation is found in the conventional TLB at decision point 806, the memory reference may be completed at block 808. When a translation is not found in the conventional TLB at block 806, the virtual address may be looked up in a conventional page table at decision point 810. When a virtual address is found in the conventional page table at decision point 810, a physical address may be computed at block 812 and the memory reference may be completed at block 808.

When a virtual address is not found in the conventional page table at decision point 810, a page fault condition may be identified at block 814 and the page may be loaded from disk at block 816. The conventional page table may be updated at block 818 and a physical address for the addressable entity may be computed at block 812 with the memory reference completed at block 808. In all cases, upon completion of the memory reference at block 808, process 800 may return to block 802 to await an instruction including an addressable entity access request.

As described above, when a new access has been requested at decision point 802, process 800 may determine whether the address is an SDSS virtual address at decision point 804. When the address is an SDSS virtual address, process 800 may check for a translation in an SDSS TLB at decision point 820. When a translation exists in the SDSS TLB at decision point 820, the memory reference may be completed at block 822. When a translation does not exist in the SDSS TLB at decision point 820, the virtual address for the addressable entity may be looked up in an SDSS page table at decision point 824. When a virtual address is found in the SDSS page table at decision point 824, a physical address may be computed at block 826 and the memory reference may be completed at block 822. When a virtual address is not found in the SDSS page table at decision point 824, an SDSS page fault may by identified at block 828 and a page may be loaded from disk at block 830 using the SDSS map table. At block 832, the SDSS page table may be updated. Again, at block 826, a physical address for the addressable entity may be computed and the memory reference may be completed at block 822. In all cases, when the memory reference is completed at block 822, process 800 may return to decision point 802 to await an instruction including an addressable entity access request.

To better illustrate the dynamic nature of the addressing of addressable entities within computer system 100, the following pseudo assembler code segment representing machine code illustrates how SDSS ISP 120 may operate upon identifiers from an SDSS virtual address space to provide access to addressable entities at the machine code level within processor 102:
01: ADD[_sdssSym0001],[_sdssSym0002]
02: STGPR1, [_sdssSym0003+4]
03: LFRAME_sdssSym0004
04: STGPR1, [SDSSF+sdssPARAM+3]
05: CALL_sdssSym0004
06: CMP[SDSSF+sdssRESULT], [_sdssSym0003+4]
07: JNE_sdssSym0005

As can be seen from line 01 of the pseudo code, an ADD instruction operates on two operands: _sdssSym0001 and _sdssSym0002. These symbolic SDSS references may point to, for example, two program variable memory areas within computer system 100. When this code is linked, _sdssSym0001 and _sdssSym0002 may be replaced with the identifiers of the SDSS virtual addresses associated with the variables. Accordingly, even when the locations where the variables are stored changes over time, the linking for these symbolic references does not need to be repeated because an MMS using an SDSS may be used to reference the new locations using the originally assigned identifiers. The result of the ADD operation may be stored in a general CPU register, such as register GPR1.

Line 02 of the pseudo code depicts an ST instruction for storing a value from register GPR1 to a symbolic reference of _sdssSym0003 in column four (4) of the referenced SDSS memory area. This instruction may operate to store the result of the ADD operation generated in line 01 to element five (e.g., 5 at index 4 with zero-based indexing) of a variable associated with an identifier from the virtual address space assigned to symbol _sdssSym0003. A multi-column or multi-element variable may be thought of as a structured variable instance. Accordingly, offsets or indices from a base reference, such as the identifier assigned for _sdssSym0003, may be possible. As with the two previous symbolic references, linking may be performed once and any further changes may be managed within the memory management system.

Line 03 of the pseudo code depicts an LFRAME instruction for locating and retrieving an instance frame for an object associated with the identifier assigned for symbolic reference _sdssSym0004. For example, _sdssSym0004 may be assigned an identifier for a function call whose instance frame may be placed into readiness by use of the LFRAME instruction. It should be noted that no stack is used within processor 102 and that the LFRAME instruction replaces conventional PUSH-type instructions for loading an address onto the stack of a conventional processor execution environment. It should also be noted that, unlike conventional processor operations, there is no requirement for a paired POP instruction when using an LFRAME instruction to set up a function call for SDSS ISP 120. As described above, a function may implement an SDSS register set 122 and access to that register set may be via either a hardware-based register set or within a memory-based register set. The LFRAME instruction may be used to place the SDSS virtual address of the instance frame in register SDSSF 202. For example, in a memory management system where data is stored by table and record, the SDSSF 202 register may contain the table ID and the record ID of the storage area where instance data, parameters, etc for the function may be stored. While the preferred embodiment does not use a stack base execution model, an alternate embodiment may use conventional processor and execution model along with a memory management system including an SDSS.

Line 04 utilizes the ST instruction again to store a value from general-purpose register GPR1 to the instance record of the function to be invoked. The instance record may hold parameters, return values, storage for instance variables, and references to global and static variables and constants. As described above, the special register SDSSF 202 may contain an SDSS virtual address of the instance frame representing an instance of the function associated with the identifier assigned for symbol _sdssSym0004. The symbol sdssPARAM may be a symbolic name for a column in the instance frame associated with an input variable of the function referenced by _sdssSym0004. Accordingly, it may represent an index or offset within the instance frame. The number 3 may be an offset or an index to the input parameter symbolically referenced by the name sdssPARAM depending on the parameter type and memory management architecture. Accordingly, the instruction at Line 04 may place the value in processor register GPR1 as an input parameter value to the function to be invoked.

Line 05 depicts a CALL instruction for invoking the function referenced by and associated with an identifier assigned for symbol _sdssSym0004, thus creating an instance of the function when processed with the data in the instance frame allocated in line03. When this instruction is executed by DBSM ISP 120, the instance frame may be made available to the function instance through a register, such as SDSSF 202, provided for addressing instance frames. This may be viewed as analogous to a register provided to reference stack frames associated with function instances in conventional stack-based machines. The function referenced by and associated with the identifier assigned for symbol _sdssSym0004 may begin execution and may operate on parameters and data passed in the instance frame using the virtual SDSS register set 112. The machine code may be generated with knowledge of the system architecture including the SDSS register set 122. As described above, the symbols used by and referenced within this pseudo code may be linked one time, including prior to the creation of an instance, and any changes to the underlying physical addresses may be resolved over time by the memory management system.

Line 06 depicts a CMP instruction executed after the function referenced by and associated with _sdssSym0004 has executed an instance and returned control to the instruction at line 06. For purposes of illustration, it is assumed that the function instance stored a result in its associated instance frame in a location associated with symbol sdssResult which may also correspond to an index or offset into the associated instance frame of the called function. The CMP instruction operates to compare the value stored in the instance frame at the location referenced by sdssResult with a value referenced by index 4 of the addressable entity associated with the symbol _sdssSym0003. The result of the comparison is indicated in a processor flag associated with the CMP instruction. The value of the flag indicates whether the compared values are equal or not. Conventional processors support analogous instructions and compares, but use conventional addresses as operands rather than SDSS addresses and operands.

Line 07 depicts a JNE instruction, which alters the flow of execution by passing control to the instruction at the virtual memory address symbolically referenced by the name _sdssSym0005 if the result of the CMP instruction at line 06 indicates the two compared values are not equal. Otherwise, control may pass to a subsequent instruction after line 07 (not shown).

The machine code represented by the assembler code illustrated above as pseudo code may be generated with knowledge of the system architecture including SDSS register set 122. As described above, the symbols used by and referenced within this pseudo code may be linked one time, including prior to the creation of an instance, and any changes to the underlying physical addresses may be resolved by the memory management system. Accordingly, reloading of the code and re-linking of these symbols may be performed only once. Further, it should be noted that the exemplary architecture does not require the use of a stack and, therefore, stack overflows cannot occur. Heap space may be shared among programs within an SDSS.

As can be seen from the pseudo code depicted and described above, SDSS identifiers may, based upon this description, be used within an SDSS runtime environment including a memory management system at a machine code-level within an instruction stream executed by processor 102. Further, these identifiers may be used at any level as actual values or symbolically within a coding hierarchy and translated to the machine code level for processing by processor 102. As described above, these identifiers/virtual addresses may be assigned at any of compile time, link time, and/or load time and need to be linked only once. Further, these identifiers/virtual addresses may further be resolved at compile time, prior to link or load time. Subsequent changes to the physical location referenced by the identifiers may be managed within a memory management system of which the exemplary embodiment includes SDSS TLB 126, SDSS page table 128, and SDSS map table 130. SDSS register set 122 enabled to support SDSS virtual memory and associated virtual addresses.

Further, upon termination of the execution of an executable system resource, the identifier associated with an addressable entity may be persistent within the SDSS so that the association may be reused. Accordingly, using the identifier corresponding to the addressable entity to access the addressable entity within a location during a subsequent processing of a machine code instruction including the identifier is possible within computer system 100.

A system for providing access to addressable entities using identifiers in a non-sequential virtual address space and/or using a structure memory may include means for assigning an identifier from a non-sequential address space to an addressable entity. For example, an identifier may be assigned to an addressable entity within MMS including SDSS when the addressable entity is loaded.

The system may further include means for associating the identifier corresponding to the addressable entity with a first memory location for storing the corresponding addressable entity. For example, when an addressable entity is loaded to processor physical memory 116, an SDSS page table entry, such as SDSS page table entry 300 may be created within SDSS page table 128 and may include a processor physical page number within column 304. Similarly, when an addressable entity is loaded to disk 118, an SDSS map table entry, such as SDSS map entry 350 may be created within SDSS map table 130 and may include a persistent physical memory address within column 354.

The system may further include means for using the identifier corresponding to the addressable entity in a machine code instruction to access the addressable entity from the first memory location during processing of a machine code instruction. Sequential or non-sequential virtual address space may be used, and the memory may be structured or unstructured. For example, ISP 120 may use the identifier to access the addressable entity during processing of a machine code instruction using the identifier as an operand.

A system for using a structured data storage system to provide access to addressable entities in a virtual address space may include means for providing an SDSS to manage a virtual address space. The virtual address space may be sequential or non-sequential. For example, an SDSS TLB 126 and an SDSS page table 128 may be provided to manage SDSS virtual memory 104.

The system may further include means for assigning, using the SDSS, an identifier to an addressable entity. For example, when an addressable entity is loaded to processor physical memory 116, an SDSS page table entry, such as SDSS page table entry 300 may be created within SDSS page table 128 and may include a physical page number in column 304 associated with the virtual page number in column 302 associated with the virtual page containing SDSS virtual memory address. In addition, when an addressable entity is loaded to disk 118, an SDSS map table entry, such as SDSS map entry 350 may be created within SDSS map table 130 and may include a persistent physical memory address within column 354.

The system may further include means for means for associating, within the SDSS, the identifier corresponding to the addressable entity with a first memory location for storing the corresponding addressable entity. For example, when an addressable entity is loaded to processor physical memory 116, an SDSS page table entry, such as SDSS page table entry 300 may be created within SDSS page table 128 and may include a processor physical page number within column 304. Similarly, when an addressable entity is loaded to disk 118, an SDSS map table entry, such as SDSS map entry 350 may be created within SDSS map table 130 and may include a persistent physical memory address within column 354.

The system may further include means for using the identifier corresponding to the addressable entity to access the addressable entity from the first memory location within the virtual address space during processing of a machine code instruction. For example, SDSS ISP 120 may use the identifier to access the addressable entity during processing of a store machine code instruction by processor 102 using a virtual memory address/identifier as an operand representing the storage location.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing access to addressable entities using a non-sequential virtual address space, the method comprising:
assigning an identifier from a non-sequential address space to an addressable entity;
associating the identifier corresponding to the addressable entity with a first memory location for storing the corresponding addressable entity; and
using the identifier corresponding to the addressable entity in a first machine code instruction to access the addressable entity from the first memory location for processing the first machine code instruction by a processor.

2. The method of claim 1 comprising storing an association of the identifier corresponding to the addressable entity with the first memory location in a memory management system (MMS).

3. The method of claim 2 wherein the memory management system includes at least one of a page table, a map table, and a TLB for enabling the mapping of a virtual address compatible with the MMS within the memory management system to a physical address.

4. The method of claim 1 wherein the first memory location includes at least one of a random access memory (RAM) location, a read-only memory (ROM) location, and a location in a persistent memory medium.

5. The method of claim 1 comprising storing the addressable entity to a second memory location and associating the identifier corresponding to the addressable entity with the second memory location in association with the storing of the corresponding addressable entity to the second memory location.

6. The method of claim 1 wherein the addressable entity includes one of an executable program function, a program object having an executable component, a virtual register, a parameter, a data variable, and a data constant.

7. The method of claim 1 wherein the first memory location includes a RAM location and wherein the method further comprises, in response to completion of processing the first machine code instruction using the identifier of the addressable entity by the processor, preserving the association of the identifier corresponding to the addressable entity and using the identifier corresponding to the addressable entity to access the addressable entity within the RAM location during a subsequent processing by the processor of a second machine code instruction using the identifier of the addressable entity.

8. The method of claim 1 wherein the first memory location includes a first RAM location and wherein the method further comprises, in response to completion of processing by the processor of the first machine code instruction using the identifier of the addressable entity, storing the addressable entity in a persistent memory location, mapping the addressable entity into a second RAM location and using the identifier corresponding to the addressable entity to access the addressable entity within the second RAM location during a subsequent processing by the processor of a second machine code instruction using the identifier of the addressable entity.

9. The method of claim 1 wherein the identifier corresponding to the addressable entity is associated with a symbol usable within a programming syntax to allow the association of the identifier corresponding to the addressable entity with the first memory location to be resolved at a machine code instruction level within a microprocessor.

10. The method of claim 1 comprising storing an association of a portion of the identifier corresponding to the addressable entity with a portion of the first memory location in a TLB and wherein using the identifier corresponding to the addressable entity to access the addressable entity during processing of the first machine code instruction includes locating in the TLB, using the portion of the identifier, a portion of a physical address of the first memory location.

11. The method of claim 1 comprising storing an association of a portion of the identifier corresponding to the addressable entity with the first memory location in a memory management system page table and wherein using the identifier corresponding to the addressable entity to access the addressable entity space during processing of the first machine code instruction includes searching the memory management system page table using the portion of the identifier and calculating a physical address of the first memory location in response to identification of the association of the portion of the identifier corresponding to the addressable entity with the first memory location in the memory management system page table.

12. The method of claim 1 wherein the first memory location comprises a persistent memory location and comprising storing an association of a portion of the identifier corresponding to the addressable entity with the persistent memory location in a map table and wherein using the identifier corresponding to the addressable entity to access the addressable entity during processing of the first machine code instruction includes searching the map table using the portion of the identifier and calculating a physical address of the persistent memory location in response to identification of the association of the portion of the identifier corresponding to the addressable entity with the persistent memory location in the map table.

13. The method of claim 1 wherein the addressable entity includes a code block and wherein the identifier is used to jump to the code block during processing of the first machine code instruction.

14. The method of claim 1 wherein the addressable entity includes a data variable and wherein the method further comprises at least one of storing a value in and reading a value from the first memory location using the identifier during processing of the first machine code instruction.

15. The method of claim 1 comprising storing the addressable entities associated with the active non-sequential virtual address space to persistent memory.

16. The method of claim 15 comprising retrieving at least a portion of the addressable entities from persistent memory.

17. The method of claim 1 wherein the non-sequential virtual address space co-exists with a sequential virtual address space.

18. The method of claim 17 wherein the first machine code instruction is accessed by the processor from within one of the sequential virtual address space and the non-sequential virtual address space.

19. The method of claim 1 wherein the addressable entity includes one of an executable addressable entity and a non-executable addressable entity.

20. The method of claim 1 wherein processing the first machine-code instruction using the identifier corresponding to the addressable entity to access the addressable entity from the first memory location includes determining whether the identifier is an MMS address.

21. The method of claim 20 wherein, in response to determining that the identifier is an MMS address, locating the addressable entity in the first memory location using at least one of a translation lookaside buffer (TLB), a page table, and a map table.

22. The method of claim 20 wherein, in response to determining that the identifier is not an MMS address, locating the first memory location using at least one of a TLB and a page table.

23. The method of claim 1 wherein using the identifier corresponding to the addressable entity to access the addressable entity from the first memory location during processing of the first machine code instruction includes processing the identifier within the processor by indexing a TLB with the identifier to locate the addressable entity within memory.

24. A system for providing access to addressable entities in a non-sequential virtual address space, the system comprising:
an MMS configured for assigning an identifier from a non-sequential address space to an addressable entity and associating the identifier corresponding to the addressable entity with a first memory location for storing the corresponding addressable entity; and
a processor configured for using the identifier corresponding to the addressable entity to access the addressable entity from the first memory location during processing of a machine code instruction.

25. A system for providing access to addressable entities in a non-sequential virtual address space, the system comprising:
a memory management system (MMS) for managing a non-sequential virtual address space; and
a processor including:
an instruction set processor (ISP) for processing a first machine code instruction that includes an identifier as an operand, where the identifier is from the non-sequential virtual address space and references an index of a location managed by the MMS for storing, at the index referenced by the identifier, an association between an addressable entity and a first memory location for storing the addressable entity; and
a memory management unit (MMU) enabled to locate the first memory location associated with the addressable entity stored at the location indexed by the identifier within the MMS to allow the processor to access the addressable entity in the first memory location during the processing of the machine code instruction by the ISP.

26. The system of claim 25 wherein the MMS includes at least one of a page table, a map table, and a translation lookaside buffer (TLB).

27. The system of claim 25 wherein the processor is adapted to process a second machine code instruction for storing the addressable entity to a second memory location and wherein the MMS is adapted to associate the identifier corresponding to the addressable entity with the second memory location for storing the corresponding addressable entity.

28. The system of claim 25 wherein the addressable entity is one of an executable program function, a program object having an executable component, a virtual register, a parameter, a data variable, and a data constant.

29. The system of claim 25 wherein the first memory location includes a first RAM location and wherein the processor is adapted to, in response to completion of processing of the first machine code instruction, store the addressable entity in a persistent memory location, to copy the addressable entity into a second RAM location, to associate the identifier with the second RAM location, and to use the identifier corresponding to the addressable entity to query the MMS for the second RAM location to access the addressable entity within the second RAM location during a subsequent processing of a second machine code instruction by the processor.

30. The system of claim 25 wherein the first memory location includes at least one of a RAM location and a memory location in a persistent memory medium.

31. The system of claim 25 wherein the identifier corresponding to the addressable entity is associated with a symbol usable within a programming syntax and wherein the MMS is adapted to use the symbol to resolve the association of the identifier corresponding to the addressable entity with the first memory location and wherein the processor is adapted to access the addressable entity at an instruction level by querying the MMS for the first memory location.

32. The system of claim 25 wherein the MMS includes at least one of a TLB, a page table, and a map table and wherein the processor is adapted to use the identifier corresponding to the addressable entity to query the at least one of the TLB, the page table, and the map table to identify a physical address of the first memory location to access the addressable entity during processing of the first machine code instruction.

33. The system of claim 25 wherein the MMS includes a map table and wherein the processor is adapted to use the identifier corresponding to the addressable entity to query the map table and wherein the processor is further adapted to calculate a physical address of the first memory location in response to identification of the association of the identifier corresponding to the addressable entity with the first memory location in the map table.

34. The system of claim 25 wherein the addressable entity includes a code block and wherein the processor is adapted to use the identifier to query the MMS for the first memory location and to jump to the code block during processing of the first machine code instruction.

35. The system of claim 25 wherein the addressable entity includes a data variable and wherein the processor is adapted to use the identifier to query the MMS for the first memory location and to perform at least one of storing a value in and retrieving a value from the first memory location during processing of the first machine code instruction.

36. The system of claim 25 wherein the processor is adapted to operate within the virtual address space and wherein the processor is further adapted to perform an operation including at least one of storing the addressable entities associated with an portion of the virtual address space to a persistent memory and retrieving the portion of the addressable entities associated with the active portion of the virtual address space from the persistent memory.

37. The system of claim 25 wherein the memory associated with the non-sequential virtual address space is a structured memory.

38. The system of claim 25 wherein the non-sequential virtual address space coexists with a sequential address space and wherein the processor is adapted to process identifiers from both the non-sequential virtual address space and the sequential virtual address space.

39. The system of claim 38 wherein the processor is adapted to execute an executable system resource associated with an identifier within one of the sequential virtual address space and the non-sequential virtual address space.

40. The system of claim 25 wherein the addressable entity includes one of an executable addressable entity and a non-executable addressable entity.

41. The system of claim 25 wherein the processor is adapted to use the identifier corresponding to the addressable entity to query the MMS for the first memory location to access the addressable entity from the first memory location during processing of the first machine code instruction.

42. The system of claim 25 wherein the MMS includes at least one of a TLB, a page table, and a map table and wherein the processor is adapted to use the identifier corresponding to the addressable entity to query the at least one of a TLB, a page table, and a map table for the first memory location to access the addressable entity from the first memory location during processing of the first machine code instruction.

43. A system for providing access to addressable entities in a non-sequential virtual address space, the system comprising:
means for assigning an identifier from a non-sequential address space to an addressable entity;
means for associating the identifier corresponding to the addressable entity with a first memory location for storing the corresponding addressable entity; and
means for using the identifier corresponding to the addressable entity to access the addressable entity from the first memory location during processing of a machine code instruction.

44. A computer program product comprising computer-executable instructions embodied in a computer-readable medium for performing steps comprising:
assigning an identifier from a non-sequential virtual address space to an addressable entity;
associating the identifier corresponding to the addressable entity with a first memory location for storing the corresponding addressable entity; and
using the identifier corresponding to the addressable entity to access the addressable entity from the first memory location during processing of a machine code instruction.
